(19) United States
(12) Patent Application Publication
(10) Pub. No.: US 2020/0057997 A1
(43) Pub. Date: Feb. 20, 2020

(54) WORK REQUEST SUPPORT SYSTEM AND NON-TRANSITORY COMPUTER READABLE MEDIUM

(71) Applicant: FUJI XEROX CO.,LTD., Tokyo (JP)

(72) Inventor: Kohei TANAKA, Kanagawa (JP)

(73) Assignee: FUJI XEROX CO.,LTD., Tokyo (JP)

(21) Appl. No.: 16/282,328

(22) Filed: Feb. 22, 2019

(30) Foreign Application Priority Data
Aug. 20, 2018 (JP) 2018-154259

(51) Int. Cl. G06Q 10/10; G06Q 10/06; G06Q 30/00; G06Q 20/10

(52) U.S. Cl. CPC G06Q 10/1097; G06Q 20/102; G06Q 30/018; G06Q 10/06398

(57) ABSTRACT

A work request support system includes a receiver that receives, from a requester who requests a person to do work, a request of work with respect to a first person who has previously engaged in a transaction with the requester, an allower that allows the first person to request a second person different from the first person to do work, and storage that stores the second person and the requester in association with each other after the allower allows the request from the first person.

### CROSS-REFERENCE TO RELATED APPLICATIONS

This application is based on and claims priority under 35 USC 119 from Japanese Patent Application No. 2018-154259 filed Aug. 20, 2018.

### BACKGROUND

### (i) Technical Field

The present disclosure relates to a work request support system and a non-transitory computer readable medium.

### (ii) Related Art

Recently, social networking services (SNS) are becoming widespread, and systems utilizing SNS are being proposed.

The system described in Japanese Unexamined Patent Application Publication No. 2014-013593 is provided with a rating input unit that receives the input of a rating by a first user with respect to a certain advertisement, a connection specification unit that specifies a second user having a connection to the first user on a social network, a rating propagation unit that notifies the second user of rating information indicating the rating by the first user, and a bonus decision unit that decides a bonus to award to the first user.

### SUMMARY

A person attempting to request work is able to use a search engine to learn of the existence of a person publicly available on a network, and is able to request work. However, the persons publicly available on a network are not limited to trustworthy persons. Also, it is also conceivable to use an SNS based on connections between individuals, but nevertheless it is still difficult to ascertain whether a person is trustworthy.

Aspects of non-limiting embodiments of the present disclosure relate to a system and the like enabling a requester or work to request work from a trustworthy person.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided a work request support system including: a receiver that receives, from a requester who requests a person to do work, a request of work with respect to a first person who has previously engaged in a transaction with the requester; an allower that allows the first person to request a second person different from the first person to do work; and storage that stores the second person and the requester in association with each other after the allower allows the request from the first person.

### BRIEF DESCRIPTION OF THE DRAWINGS

Exemplary embodiments of the present disclosure will be described in detail based on the following figures, wherein:

FIG. 1 is a diagram illustrating an example of a schematic configuration of a work request support system according to an exemplary embodiment;

FIG. 2 is a diagram illustrating an example of a schematic configuration of a user terminal;

FIG. 3 is a block diagram illustrating an example of a functional configuration of a server;

FIG. 4 is a diagram illustrating one example of a management screen displayed on the user terminal of a user who uses the system;

FIG. 5 is a diagram illustrating one example of a registrant screen displayed on the user terminal;

FIG. 6 is a diagram illustrating one example of a work request screen displayed on the user terminal;

FIG. 7 is a diagram illustrating a response screen displayed on the user terminal of a user who has been requested to do work;

FIG. 8 is a diagram illustrating an answer screen displayed on the user terminal of a user who has been asked a question;

FIG. 9 is a diagram illustrating a response screen displayed on the user terminal of a user who has obtained an answer;

FIG. 10 is a diagram illustrating an acceptance screen displayed on the user terminal of a requester;

FIG. 11 is a diagram illustrating a delivery screen displayed on the user terminal of an accepter;

FIG. 12 is a diagram illustrating an inspection screen displayed on the user terminal of the requester;

FIG. 13 is a diagram illustrating a completion screen displayed on the user terminal of the accepter;

FIG. 14 is a diagram illustrating a remuneration setting screen displayed on the user terminal of the requester;

FIG. 15 is a diagram illustrating one example of a work request screen displayed on the user terminal of a primary accepter;

FIG. 16 is a diagram illustrating one example of a notification screen indicating that the primary accepter has requested a secondary accepter to do a part of the requested work;

FIG. 17 is a diagram illustrating one example of a management screen displayed on the user terminal; and

FIG. 18 is a diagram illustrating one example of an approval screen.

### DETAILED DESCRIPTION

Hereinafter, exemplary embodiments will be described in detail and with reference to the attached drawings.

### First Exemplary Embodiment

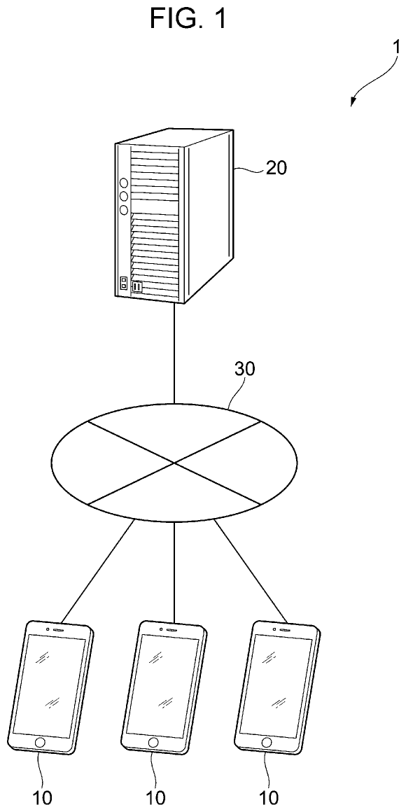

FIG. 1 is a diagram illustrating an example of a schematic configuration of a work request support system 1 according to the present exemplary embodiment.

The work request support system 1 is provided with user terminals 10 carried by users and a server 20 that provides a communication service assisting work transactions between users over a network 30. The user terminals 10 and the server 20 are able to communicate with each other through the network 30. The network 30 is not particularly limited insofar as the network is a communication network used to communicate data among systems and apparatus, and may be a local area network (LAN), a wide area network (WAN), the Internet, or the like, for example. The communication link used for data communication may be wired, wireless, or a combination of the two. Also, a relay apparatus such as a gateway apparatus or a router may be used to connect each apparatus through multiple networks and communication links.

<User Terminal 10>

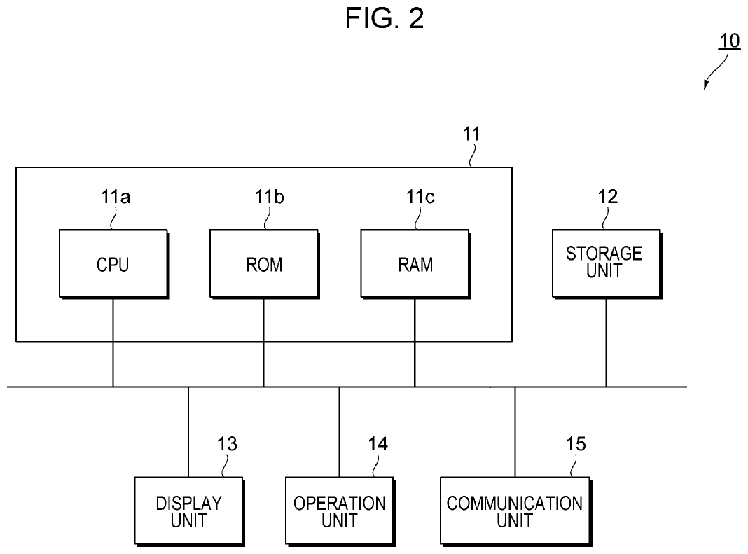

FIG. 2 is a diagram illustrating an example of a schematic configuration of one of the user terminals 10.

The user terminal 10 is provided with a control unit 11 that controls the apparatus as a whole, a storage unit 12 used to store and the like, a display unit 13 used to display an operation receiving screen and images, an operation unit 14 that receives input operations by the user, and a communication unit 15 used to communicate with external apparatus.

The control unit 11 includes a central processing unit (CPU) 11a, read-only memory (ROM) 11b, and random access memory (RAM) 11c. The ROM 11b stores a base program (operating system) executed by the CPU 11a, various settings, and the like. The CPU 11a uses the RAM 11c as a work area to execute application programs read out from the ROM 11b and the storage unit 12. By the CPU 11a executing programs, each unit of the user terminal is controlled.

The storage unit 12 may be for example a storage device such as semiconductor memory.

The display unit 13 is a display device that displays still images, moving images, and the like. The display unit 13 may be for example a liquid crystal display or an organic electro-luminescence (EL) display.

The operation unit 14 is an input device that receives operations from the user. The operation unit 14 may be for example one or more buttons and switches or a touch panel.

The communication unit 15 may be for example a communication interface.

The user terminal 10 configured as above may be for example a multi-functional mobile phone (also referred to as a “smartphone”), a mobile phone (also referred to as a “feature phone”), a mobile information terminal (PDA), a tablet, a tablet PC, a laptop PC, a desktop PC, or the like.

<Server 20>

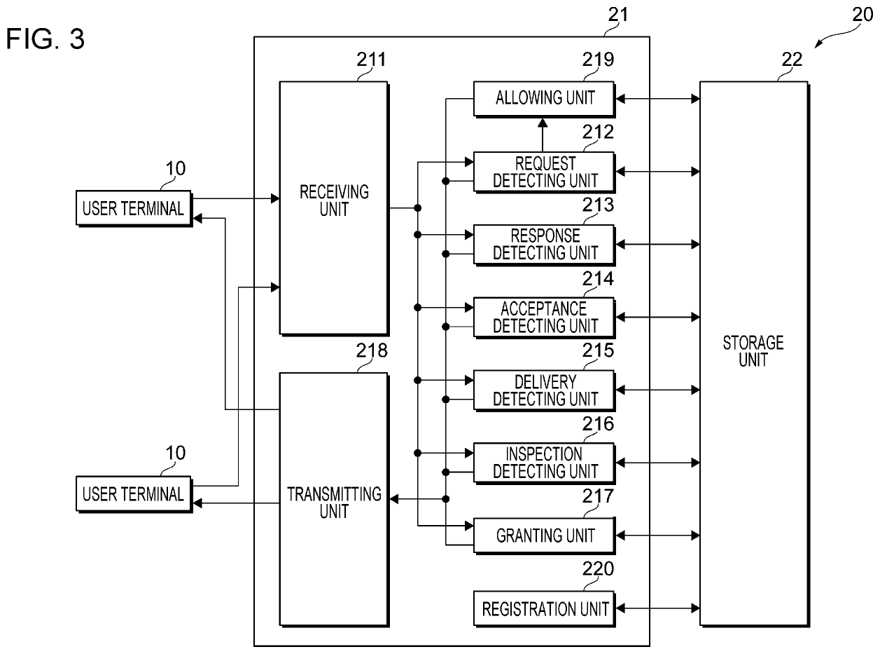

FIG. 3 is a block diagram illustrating an example of a functional configuration of the server 20.

Similarly to the control unit 11, the storage unit 12, the display unit 13, the operation unit 14, and the communication unit 15 provided in the user terminal 10, the server 20 is provided with a control unit 21, storage unit 22, a display unit (not illustrated), an operation unit (not illustrated), and a communication unit (not illustrated). The storage unit 22 may be a hard disk drive (HDD).

The server 20 provides a communication service assisting work transactions between users stored in the storage unit 22 over the network 30.

The storage unit 22 stores information related to the users. The information related to the users may be for example the names, email addresses, and phone numbers of the users. Also, the storage unit 22 stores a first user in association with a second user in the case in which a predetermined relationship exists. In other words, the storage unit 22 stores connections between users. The predetermined relationship may be for example a relationship of belonging to the same organization or a relationship of belonging to the same community. Also, the predetermined relationship also includes the case of a relationship in which the first user and the second user have participated in a transaction directly or indirectly in the past. For example, in the case in which the second user accepts work from a third person who has accepted work requested by the first user, the first user and the second user are stored in association with each other as a relationship in which the first user and the second user have participated in a transaction.

The control unit 21 includes a CPU (not illustrated), ROM (not illustrated), RAM (not illustrated), and the like, and by having the CPU execute programs, the following functions are realized.

Namely, the control unit 21 includes a receiving unit 211 that receives information transmitted from the user terminals 10.

Also, the control unit 21 includes a request detecting unit 212 that analyzes the information received by the receiving unit 211 and thereby detects that work has been requested from the first user to the second user. In the following, the user who requests someone to do work will be designated the “requester” in some cases.

Also, the control unit 21 includes a response detecting unit 213 that analyzes the information received by the receiving unit 211 and thereby detects that the user requested to do work by the requester has asked the requester a question, or that the requester asked a question has provided an answer.

Also, the control unit 21 includes an acceptance detecting unit 214 that analyzes the information received by the receiving unit 211 and thereby detects that the user requested to do work by the requester has accepted the requested work. In the following, the person who accepts requested work will be designated the “accepter” in some cases.

Also, the control unit 21 includes a delivery detecting unit 215 that analyzes the information received by the receiving unit 211 and thereby detects that work has been delivered by the accepter.

Also, the control unit 21 includes an inspection detecting unit 216 that analyzes the information received by the receiving unit 211 and thereby detects that the requester has inspected the product delivered by the accepter.

Also, the control unit 21 includes a granting unit 217 that analyzes the information received by the receiving unit 211 and thereby ascertains a remuneration decided by the requester and also grants the remuneration to the accepter.

Also, the control unit 21 includes a transmitting unit 218 that transmits various information to users. For example, the transmitting unit 218 transmits information indicating that a work request has arrived to users who have received work requests from the requester. Also, the transmitting unit 218 transmits information to the requester indicating that a user who has received a work request has accepted the requested work. Also, the transmitting unit 218 transmits information to the requester indicating that work has been delivered by the accepter. Also, the transmitting unit 218 transmits information to the accepter indicating that the work has been inspected by the requester. Also, the transmitting unit 218 transmits information to the accepter indicating that a remuneration has been granted.

Also, the control unit 21 includes an allowing unit 219 that allows the accepter to request another user different from the requester to do work.

Also, the control unit 21 includes a registration unit 220 that, in the case in which the first user and the second user exist in a predetermined relationship, stores the first user and the second user in association with each other in the storage unit 22.

Hereinafter, the functions of each unit will be described in detail.

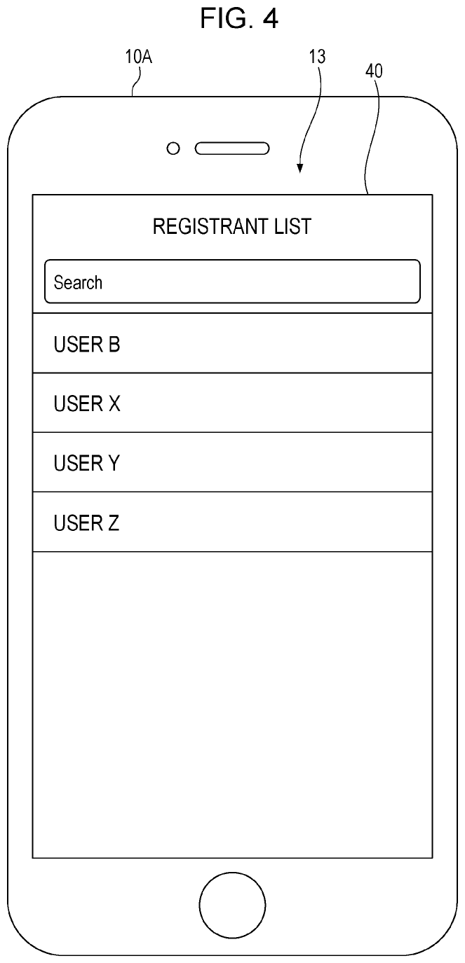

FIG. 4 is a diagram illustrating one example of a management screen 40 displayed on the user terminal 10A of a user who uses the system.

When the user who uses the system launches a dedicated application installed on the user terminal 10, the management screen 40 exemplified in FIG. 4 is displayed on the display unit 13 of the user terminal 10. In other words, the control unit 11 of the user terminal 10 causes the management screen 40 to be displayed on the display unit 13 in the case in which the user performs an operation for displaying the management screen 40.

On the management screen 40, persons (hereinafter designated “registrants” in some cases) stored in association with the user carrying the user terminal 10 in the storage unit 22 of the server 20 are displayed.

In the example illustrated in FIG. 4, User B, User X, User Y, and User Z are displayed as registrants on the management screen 40 of the user terminal 10A of User A.

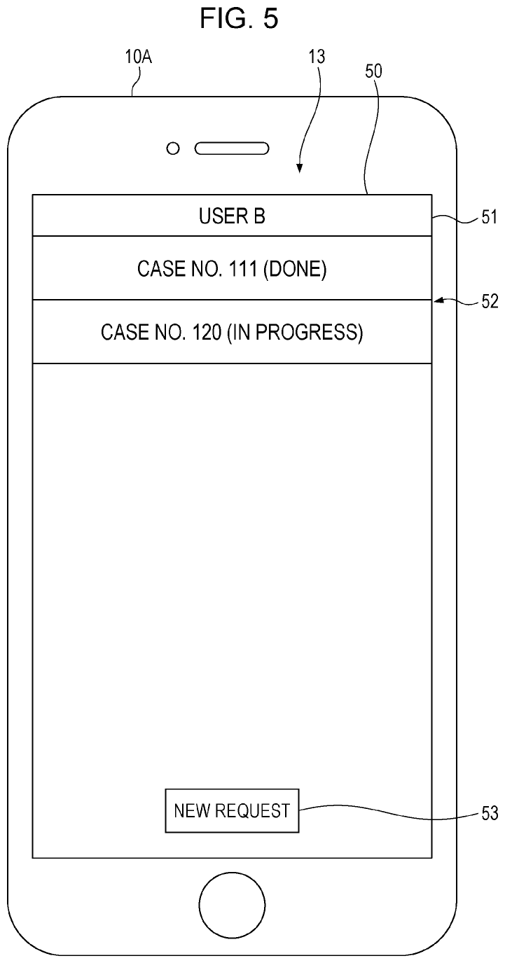

FIG. 5 is a diagram illustrating one example of a registrant screen 50 displayed on the user terminal 10A.

The registrant screen 50 is displayed when the user selects a person displayed on the management screen 40. On the registrant screen 50, a name field 51 displaying the name of the selected person and a case display field 52 displaying cases that have been negotiated with the person and already finished as well as cases currently in progress are displayed. Also, on the registrant screen 50, a new request button 53 labeled “New Request” for requesting the selected person to do new work is displayed.

For example, in the example illustrated in FIG. 5, User B is displayed in the name field 51 of the registrant screen 50 on the user terminal 10A of User A, and in the case display field 52, a case number 111 is displayed as a finished case and a case number 120 is displayed as a case in progress.

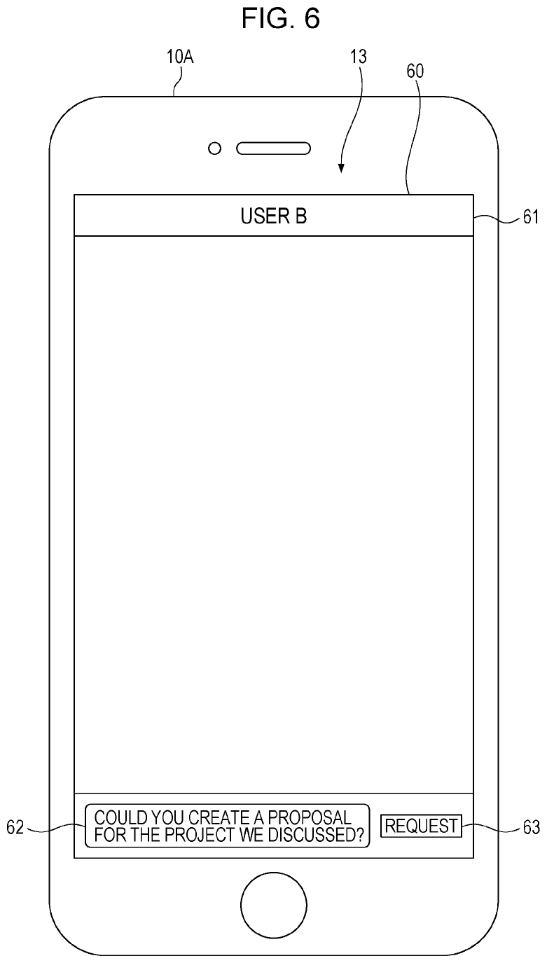

FIG. 6 is a diagram illustrating one example of a work request screen 60 displayed on the user terminal 10A.

The work request screen 60 is displayed when the user presses the new request button 53 displayed on the registrant screen 50. In other words, the control unit 11 causes the display unit 13 to display the work request screen 60 in the case of detecting that the new request button 53 on the registrant screen 50 has been pressed.

On the work request screen 60, a name field 61 displaying the name of the person to request to do work, an input field 62 for inputting the content of the work, and a request button 63 labeled “Request” for requesting the work input into the input field 62 are displayed.

For example, in the example illustrated in FIG. 6, User B is displayed in the name field 61 of the work request screen 60 on the user terminal 10A of User A, and “Could you create a proposal for the project we discussed?” has been input into the input field 62 as the content of the desired work to request.

When the user presses the request button 63 displayed on the work request screen 60, the receiving unit 211 of the control unit 21 of the server 20 receives information indicating that the request button 63 has been pressed. Subsequently, the request detecting unit 212 analyzes the information received by the receiving unit 211 and thereby detects that work has been requested. For example, in the case in which the receiving unit 211 receives an indication that the request button 63 on the work request screen 60 illustrated in FIG. 6 has been pressed, the request detecting unit 212 detects that the work input into the input field 62 has been requested from User A to User B, and stores the content of the work in the storage unit 22. Subsequently, the transmitting unit 218 transmits information to User B indicating that a work request from User A has arrived.

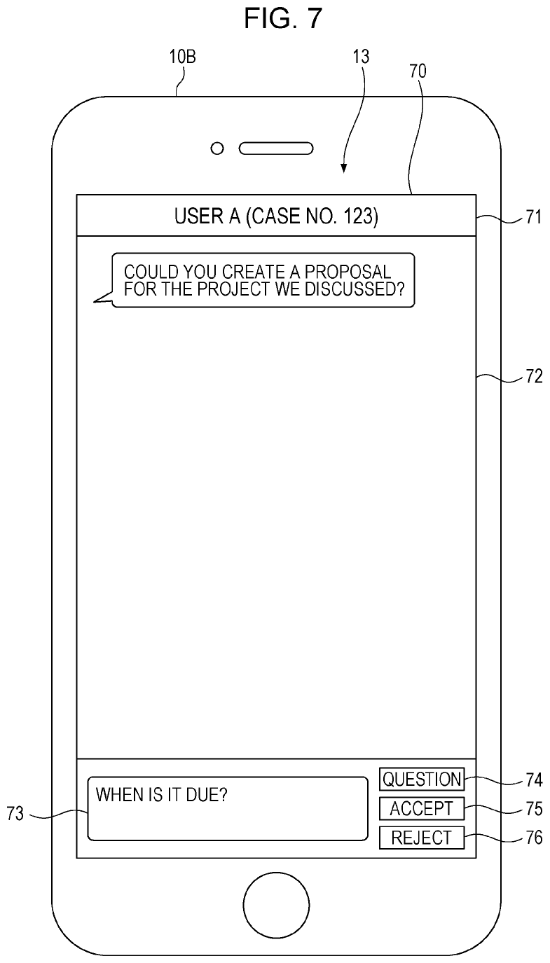

FIG. 7 is a diagram illustrating a response screen 70 displayed on the user terminal 10B of a user who has been requested to do work.

The response screen 70 is displayed by the display unit 13 of the user terminal 10 in the case in which the user requested to do the work, having received information about the work transmitted by the transmitting unit 218, performs a predetermined operation on the user terminal 10. The predetermined operation may be for example pressing the name of the requester displayed after pressing an icon of a dedicated application for the system installed on the user terminal 10.

On the response screen 70, a name field 71 displaying the name of the person requesting the work is provided. In the name field 71, the case number assigned by the request detecting unit 212 of the control unit 21 is also displayed. In addition, on the response screen 70, a history field 72 displaying a history of messages exchanged in the past with the person displayed in the name field 71 in relation to the work with the case number displayed in the name field 71 is provided. Also, on the response screen 70, an input field 73 for inputting a message and a question button 74 labeled “Question” for asking about the matter input into the input field 73 are displayed. Also, on the response screen 70, an accept button 75 labeled “Accept” for accepting requested work and reject button 76 labeled “Reject” for not accepting requested work are displayed.

For example, in the example illustrated in FIG. 7, User A and case number 123 are displayed in the name field 71 of the response screen 70 of the user terminal 10B of User B, and in the history field 72, the content of the work requested by User A is displayed. Also, in the example illustrated in FIG. 7, the question “When is it due?” is input into the input field 73.

When the user presses the question button 74 displayed on the response screen 70, the receiving unit 211 of the control unit 21 of the server 20 receives information indicating that the question button 74 has been pressed. Subsequently, the response detecting unit 213 analyzes the information received by the receiving unit 211 and thereby detects that a question has been asked. For example, in the case in which the receiving unit 211 receives an indication that the question button 74 on the response screen 70 illustrated in FIG. 7 has been pressed, the response detecting unit 213 detects that User B has asked User A the question input into the input field 73, and stores the content of the question in the storage unit 22. Subsequently, the transmitting unit 218 transmits information to User A indicating that a question from User B has arrived.

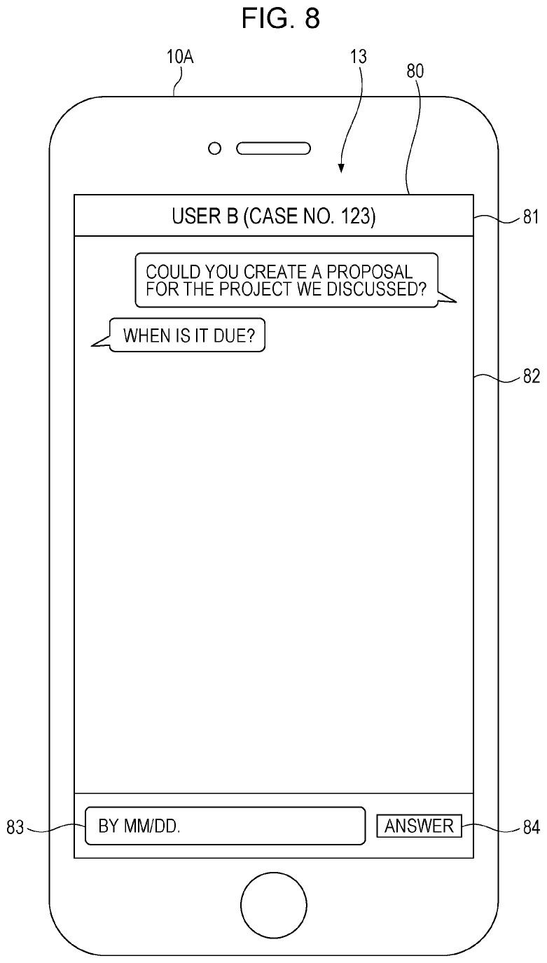

FIG. 8 is a diagram illustrating an answer screen 80 displayed on the user terminal 10A of a user who has been asked a question.

The answer screen 80 is displayed by the display unit 13 of the user terminal 10 in the case in which the user asked the question, having received information about the question transmitted by the transmitting unit 218, performs a predetermined operation on the user terminal 10.

On the answer screen 80, a name field 81 displaying the name of the person asking the question and the case number is provided. In addition, on the answer screen 80, a history field 82 displaying a history of messages exchanged in the past with the person displayed in the name field 81 in relation to the work with the case number is provided. Also, on the answer screen 80, an input field 83 for inputting a message and an answer button 84 labeled “Answer” for answering the matter input into the input field 83 are displayed.

For example, in the example illustrated in FIG. 8, User B and the case number 123 are displayed in the name field 81 on the answer screen 80 of the user terminal 10A of User A, and in the history field 82, the content of the question asked by User B is displayed. Also, in the example illustrated in FIG. 8, the answer “By MM/DD.” is input into the input field 83.

When the user presses the answer button 84 displayed on the answer screen 80, the receiving unit 211 of the control unit 21 of the server 20 receives information indicating that the answer button 84 has been pressed. Subsequently, the response detecting unit 213 analyzes the information received by the receiving unit 211 and thereby detects that an answer has been given. For example, in the case in which the receiving unit 211 receives an indication that the answer button 84 on the answer screen 80 illustrated in FIG. 8 has been pressed, the response detecting unit 213 detects that User A has given the answer input into the input field 83 to User B, and stores the content of the answer in the storage unit 22. Subsequently, the transmitting unit 218 transmits information to User B indicating that an answer from User A has arrived.

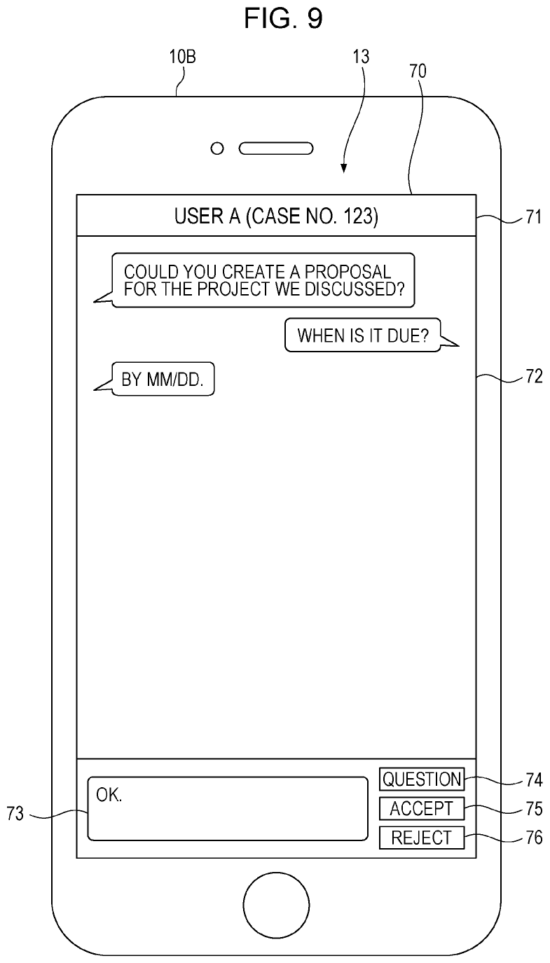

FIG. 9 is a diagram illustrating a response screen 70 displayed on the user terminal 10B of a user who has obtained an answer.

In the history field 72 of the response screen 70, as described above, a history of messages exchanged in the past with the person displayed in the name field 71 in relation to the work with the case number displayed in the name field 71 is displayed, with the currently obtained answer displayed lowermost.

When the user presses the accept button 75 displayed on the response screen 70, the receiving unit 211 of the control unit 21 of the server 20 receives information indicating that the accept button 75 has been pressed. Subsequently, the acceptance detecting unit 214 analyzes the information received by the receiving unit 211 and thereby detects that the work requested by the requester has been accepted. For example, in the case in which the receiving unit 211 receives an indication that the accept button 75 on the response screen 70 illustrated in FIG. 9 has been pressed, the acceptance detecting unit 214 detects that User B has accepted the work with the case number 123 requested by User A, and stores the content of the acceptance in the storage unit 22. Subsequently, the transmitting unit 218 transmits information to User A indicating that User B has accepted the work.

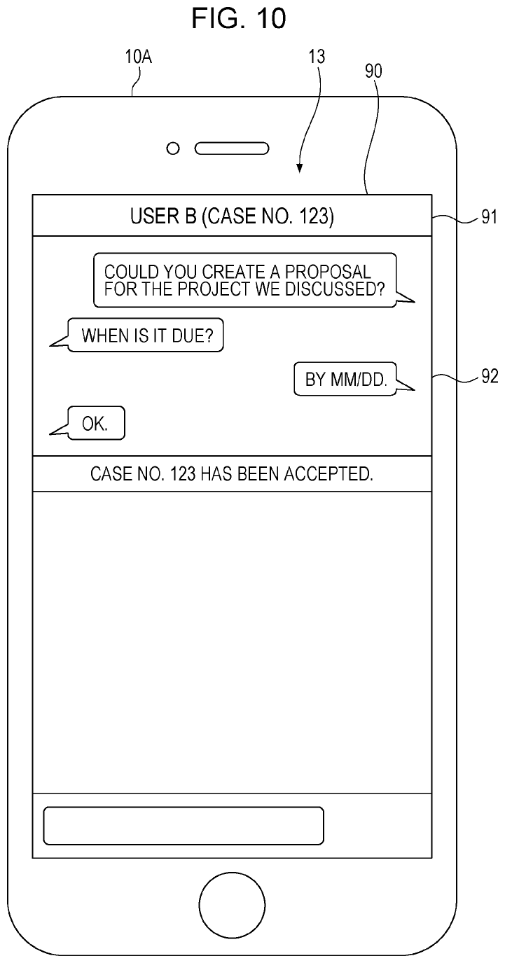

FIG. 10 is a diagram illustrating an acceptance screen 90 displayed on the user terminal 10A of the requester.

The acceptance screen 90 is displayed by the display unit 13 of the user terminal 10 in the case in which the requester, having received information transmitted by the transmitting unit 218, performs a predetermined operation on the user terminal 10.

On the acceptance screen 90, a name field 91 displaying the name of the accepting person and the case number is provided. In addition, on the acceptance screen 90, a history field 92 displaying a history of messages exchanged in the past with the person displayed in the name field 91 in relation to the work with the case number displayed in the name field 91 is provided, and at the bottom of the history field 92, an indication that the requested work has been accepted is displayed.

For example, in the example illustrated in FIG. 10, User B and the case number 123 are displayed in the name field 91 on the acceptance screen 90 of the user terminal 10A of User A who is the requester, and at the bottom of the history field 92, “Case No. 123 has been accepted.” is displayed.

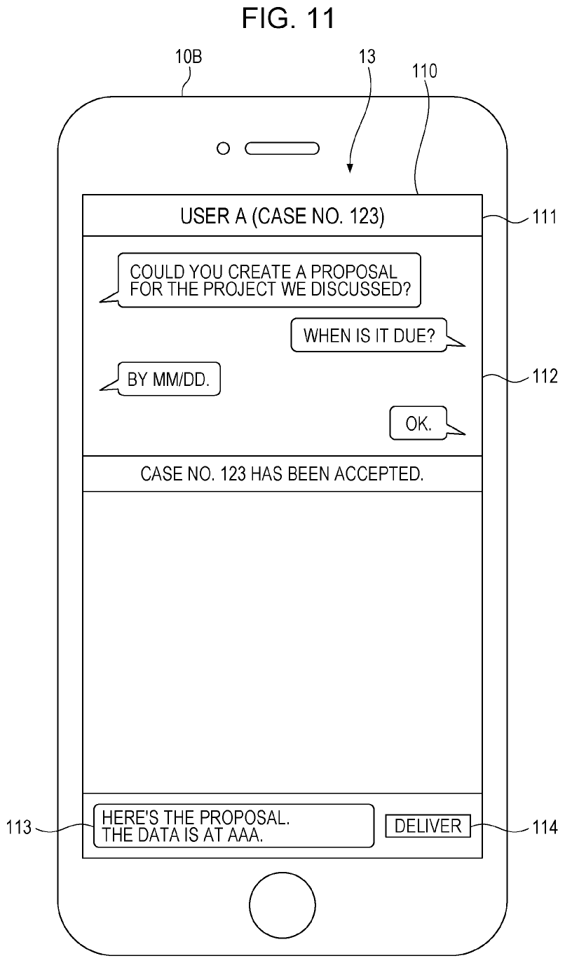

FIG. 11 is a diagram illustrating a delivery screen 110 displayed on the user terminal 10B of the accepter.

The delivery screen 110 is displayed on the display unit 13 in the case in which, after the accepter accepts the work requested by the requester (after the accept button 75 on the response screen 70 is pressed), the accepter presses the part where the case number is displayed on the registrant screen 50 for the requester.

On the delivery screen 110, a name field 111 displaying the requester and the case number is displayed. In addition, on the delivery screen 110, a history field 112 displaying a history of messages exchanged in the past with the person displayed in the name field 111 in relation to the work with the case number displayed in the name field 111 is provided. Also, on the delivery screen 110, an input field 113 for inputting a message and a deliver button 114 labeled “Deliver” are displayed.

At the bottom of the history field 112, language for clearly stating that the accepter has accepted the work requested by the requester is displayed.

For example, in the example illustrated in FIG. 11, User A and case number 123 are displayed in the name field 111 on the delivery screen 110 of the user terminal 10B of User B, and in the history field 112, a history of the messages so far and language stating that “Case No. 123 has been accepted.” are displayed. Also, in the example illustrated in FIG. 11, the message “Here's the proposal. The data is at AAA.” given when User B delivers the work is input into the input field 113.

When the user presses the deliver button 114 displayed on the delivery screen 110, the receiving unit 211 of the control unit 21 of the server 20 receives information indicating that the deliver button 114 has been pressed. Subsequently, the delivery detecting unit 215 analyzes the information received by the receiving unit 211 and thereby detects that the accepter has delivered a product corresponding to the requested work. For example, in the case in which the receiving unit 211 receives an indication that the deliver button 114 on the delivery screen 110 illustrated in FIG. 11 has been pressed, the delivery detecting unit 21S detects that User B has delivered the product corresponding to the work with the case number 123 requested by User A, and stores the content of the delivery in the storage unit 22. Subsequently, the transmitting unit 218 transmits information to User A indicating that User B has delivered the work product.

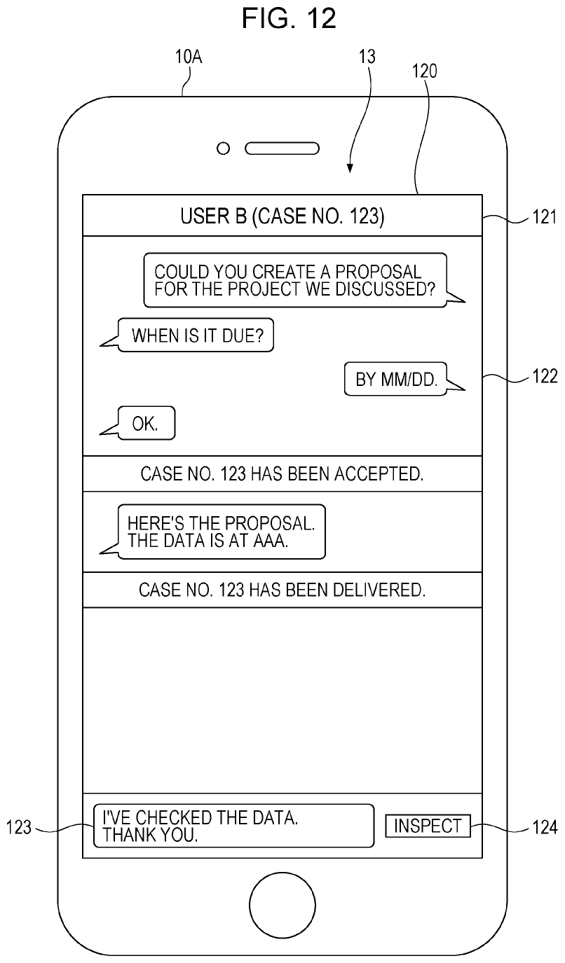

FIG. 12 is a diagram illustrating an inspection screen 120 displayed on the user terminal 10A of the requester.

The inspection screen 120 is displayed on the display unit 13 in the case in which, after the requester receives the delivered product corresponding to the requested work from the accepter (after the deliver button 114 on the delivery screen 110 is pressed), the requester presses the part where the case number is displayed on the registrant screen 50 for the accepter.

On the inspection screen 120, a name field 121 displaying the accepter and the case number is displayed. In addition, on the inspection screen 120, a history field 122 displaying a history of messages exchanged in the past with the person displayed in the name field 121 in relation to the work with the case number displayed in the name field 121 is provided. Also, on the inspection screen 120, an input field 123 for inputting a message and an inspect button 124 labeled “Inspect” are displayed. At the bottom of the history field 122, language for clearly stating that the accepter has delivered the product corresponding to the work requested by the requester is displayed.

For example, in the example illustrated in FIG. 12, User B and the case number 123 are displayed in the name field 121 on the inspection screen 120 of the user terminal 10A of User A, and at the bottom of the history field 122, “Case No. 123 has been delivered.” is displayed. Also, in the example illustrated in FIG. 12, the message “I've checked the data. Thank you.” given when User A inspects the work product is input into the input field 123.

When the user presses the inspect button 124 displayed on the inspection screen 120, the receiving unit 211 of the control unit 21 of the server 20 receives information indicating that the inspect button 124 has been pressed. Subsequently, the inspection detecting unit 216 analyzes the information received by the receiving unit 211 and thereby detects that the product delivered by the accepter has been inspected. For example, in the case in which the receiving unit 211 receives an indication that the inspect button 124 on the inspection screen 120 illustrated in FIG. 12 has been pressed, the inspection detecting unit 216 detects that User A has inspected the product corresponding to the work with the case number 123 delivered by User B, and stores the content of the inspection in the storage unit 22. Subsequently, the transmitting unit 218 transmits information to User B indicating that User A has inspected the work product.

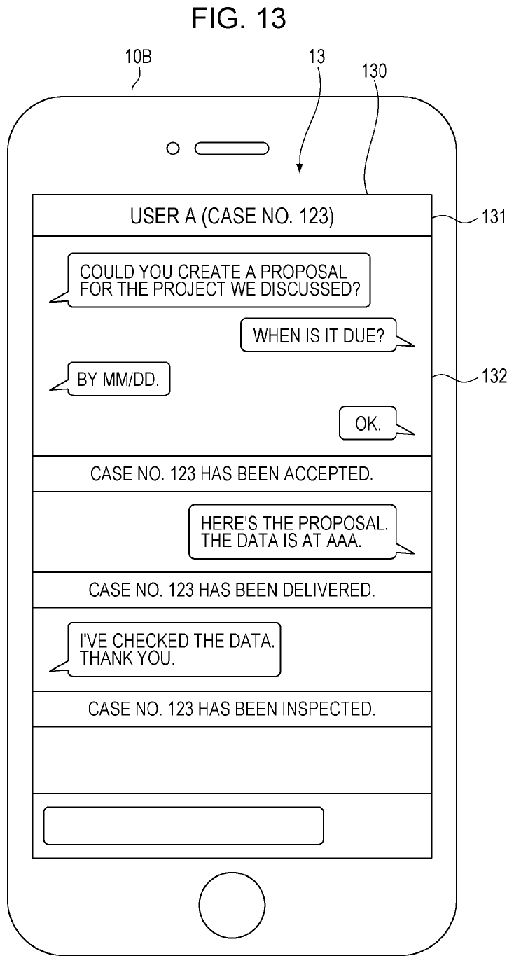

FIG. 13 is a diagram illustrating a completion screen 130 displayed on the user terminal 10B of the accepter.

The completion screen 130 is displayed on the display unit 13 in the case in which, after the requester has finished inspecting the product delivered by the accepter (after the inspect button 124 on the inspection screen 120 is pressed), the accepter presses the part where the case number is displayed on the registrant screen 50 for the requester.

On the completion screen 130, a name field 131 displaying the requester and the case number is displayed. In addition, on the completion screen 130, a history field 132 displaying a history of messages exchanged in the past with the requester in relation to the work with the case number displayed in the name field 131 is provided, and at the bottom of the history field 132, an indication that the delivered product has been inspected is displayed.

For example, in the example illustrated in FIG. 13, User A and the case number 123 are displayed in the name field 131 on the completion screen 130 of the user terminal 10B of User B, and at the bottom of the history field 132, “Case No. 123 has been inspected.” is displayed.

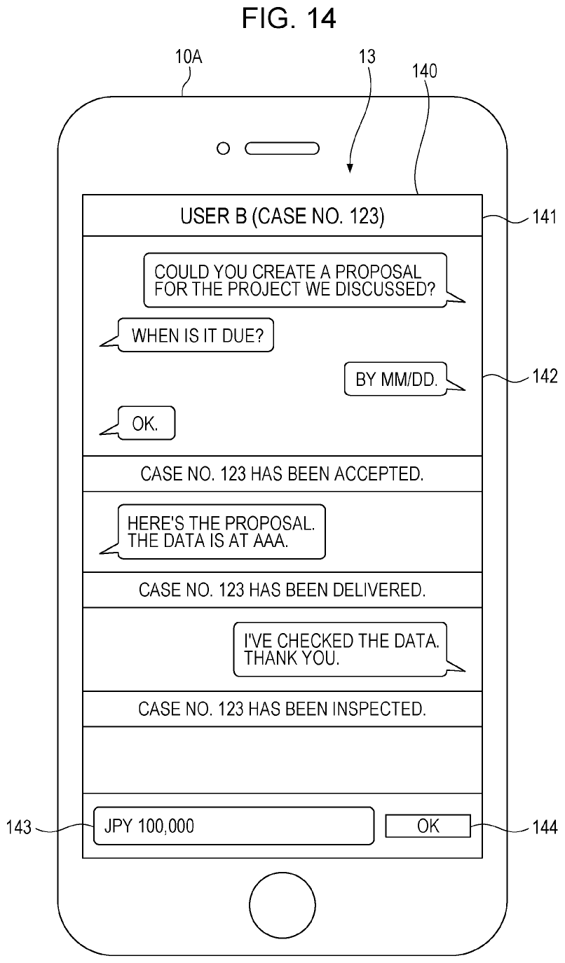

FIG. 14 is a diagram illustrating a remuneration setting screen 140 displayed on the user terminal 10A of the requester.

The remuneration setting screen 140 is displayed on the display unit 13 in the case in which, after the requester has finished inspecting the delivered product (after the inspect button 124 on the inspection screen 120 is pressed), the requester presses the part where the case number is displayed on the registrant screen 50 for the accepter.

On the remuneration setting screen 140, a name field 141 displaying the accepter and the case number is displayed. In addition, on the remuneration setting screen 140, a history field 142 displaying a history of messages exchanged in the past with the accepter in relation to the work with the case number displayed in the name field 141 is provided, and at the bottom of the history field 142, an indication that the delivered product has been inspected is displayed. Also, on the remuneration setting screen 140, an input field 143 for inputting a remuneration and a decide button 144 labeled “OK” are displayed.

For example, in the example illustrated in FIG. 14, User B and the case number 123 are displayed in the name field 141 on the remuneration setting screen 140 of the user terminal 10A of User A who is the requester, and at the bottom of the history field 142, “Case No. 123 has been inspected.” is displayed. Also, in the example illustrated in FIG. 14, the remuneration “JPY 100,000” to pay to the accepter is input into the input field 143.

When the user presses the decide button 144 displayed on the remuneration setting screen 140, the receiving unit 211 of the control unit 21 of the server 20 receives information indicating that the decide button 144 has been pressed. Subsequently, the granting unit 217 analyzes the information received by the receiving unit 211 and thereby detects that the remuneration to pay to the primary accepter has been decided. For example, in the case in which the receiving unit 211 receives an indication that the decide button 144 on the remuneration setting screen 140 illustrated in FIG. 14 has been pressed, the granting unit 217 detects that User A has decided to pay User B the remuneration input into the input field 143, and stores the decided content in the storage unit 22. Subsequently, the granting unit 217 grants the remuneration input into the input field 143 to User B according to a method registered in advance. The method of granting may be, for example, transferring funds to a bank account registered by the user.

Note that the granting unit 217 granting a remuneration causes the transaction of the current case to end, and in the case display field 52 on the registrant screen 50, the current case is displayed as a finished case.

Next, the allowing unit 219 will be described.

The allowing unit 219 of the server 20 determines whether or not to allow the primary accepter, that is, the accepter who has been requested to do work by the requester, to request another person to do a part of the work requested by the requester.

It is possible for the primary accepter to want to request another person to do work through the work request screen 60 illustrated in FIG. 6.

In other words, the primary accepter is able to want to request another person to do work by pressing the new request button 53 on the registrant screen 50 corresponding to a person selected via the management screen 40 displayed on the user terminal 10. In other words, the primary accepter is able to express to the server 20 an intention of wanting to request a person selected from among the persons (registrants) displayed on the management screen 40 to do work.

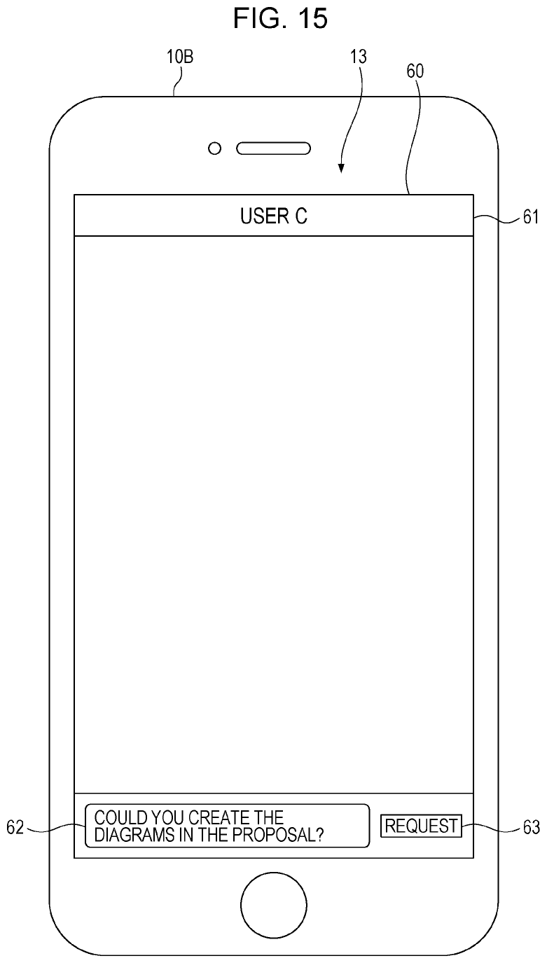

FIG. 15 is a diagram illustrating one example of the work request screen 60 displayed on the user terminal 10B of the primary accepter.

For example, in the example illustrated in FIG. 15, User C is displayed in the name field 61 of the work request screen 60 on the user terminal 10B of User B who is the primary accepter, and “Could you create the diagrams in the proposal?” has been input into the input field 62 as the content of the desired work to request. Subsequently, in the case in which the receiving unit 211 of the server 20 receives an indication that the request button 63 on the work request screen 60 illustrated in FIG. 15 has been pressed, the request detecting unit 212 detects that the primary accepter, namely User B, wants to request User C to do the work input into the input field 62.

The allowing unit 219 according to the first exemplary embodiment allows the request in the case in which the person who is the candidate to receive a request of work from the primary accepter (hereinafter designated the “candidate” in some cases) is a person who has engaged in a transaction with the primary accepter in the past. In other words, the allowing unit 219 allows the request in the case in which the storage unit 22 is storing information indicating that the primary accepter has requested the candidate to do work in the past, and the work was delivered and inspected successfully.

In the case in which the allowing unit 219 allows the request, the transmitting unit 218 of the server 20 notifies the candidate that a work request from the primary accepter has arrived, and also notifies the primary accepter that the work request has been allowed. On the other hand, in the case in which the allowing unit 219 does not allow the request, the transmitting unit 218 notifies the primary accepter that the request to the candidate is not allowed.

For example, in the example illustrated in FIG. 15, in the case in which User B presses the request button 63 on the work request screen 60 and the allowing unit 219 allows User B to request User C to do work, the transmitting unit 218 notifies User C that a work request from User B has arrived. Additionally, the transmitting unit 218 notifies User B that the work request to User C has been allowed. On the other hand, in the case in which the allowing unit 219 does not allow User B to request User C to do work, the transmitting unit 218 notifies User B that the work request to User C has not been allowed.

The person requested to do work by the primary accepter is able to ask a question about the content of the request via the response screen 70 exemplified in FIG. 7.

Also, the primary accepter is able to answer a question about the content via the answer screen 80 exemplified in FIG. 8.

Also, the person requested to do work by the primary accepter is able to accept the requested work via the response screen 70 exemplified in FIG. 7.

Hereinafter, the person who accepts work requested by the primary accepter will be designated the “secondary accepter” in some cases. In such cases, from the point of view of the secondary accepter, the requester is the primary accepter.

The secondary accepter is able to deliver a product corresponding to the requested work via the delivery screen 110 exemplified in FIG. 11.

The primary accepter is able to inspect a delivered product via the inspection screen 120 exemplified in FIG. 12.

The primary accepter is able to decide a remuneration to pay to the secondary accepter via the remuneration setting screen 140 exemplified in FIG. 14.

Additionally, the granting unit 217 of the control unit 21 of the server 20 grants the remuneration decided by the primary accepter to the secondary accepter according to a method registered in advance.

In the case in which the primary accepter requests the secondary accepter to do a part of the work requested by the requester, the product delivered by the primary accepter is a product completed by the cooperation of the primary accepter and the secondary accepter. The transmitting unit 218 of the server 20 transmits information to the requester indicating that the primary accepter has requested the secondary accepter to do a part of the requested work, and that the product delivered by the primary accepter is a product completed by the cooperation of the primary accepter and the secondary accepter. Also, the transmitting unit 218 transmits, to the requester, information about the specific content of the work that the primary accepter has requested the secondary accepter to do. For example, in the example described above, the transmitting unit 218 notifies User A with information indicating that User B has requested User C to create the diagrams in the proposal that User A requested User B to create.

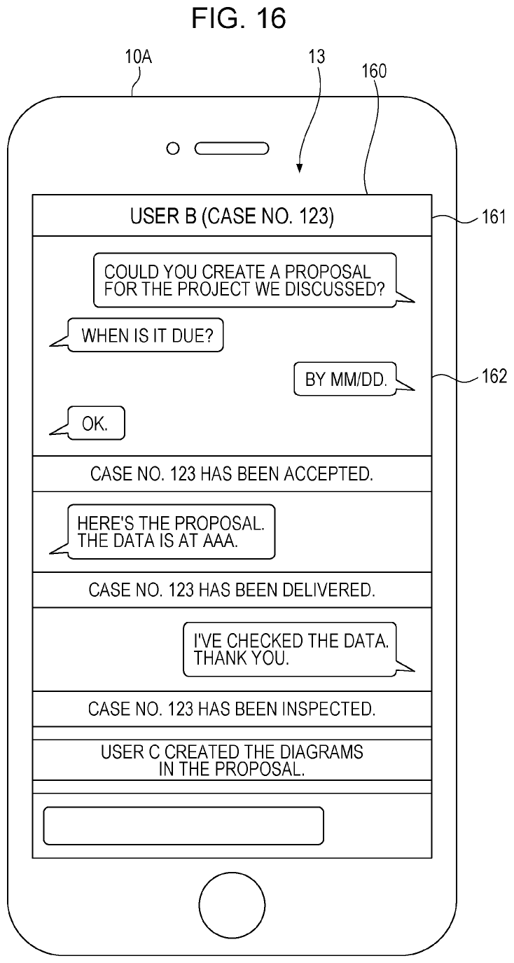

FIG. 16 is a diagram illustrating one example of a notification screen 160 indicating that the primary accepter has requested the secondary accepter to do a part of the requested work.

The timing when the transmitting unit 218 of the control unit 21 of the server 20 notifies the requester with information indicating that the primary accepter has requested the secondary accepter to do a part of the requested work is not particularly limited. For example, the timing may be after the requester presses the inspect button 124 on the inspection screen 120 illustrated in FIG. 12.

The notification screen 160 is displayed on the display unit 13 in the case in which, after the requester is notified by the transmitting unit 218, the requester presses the part where the case number is displayed on the registrant screen 50 for the primary accepter.

On the notification screen 160, a name field 161 displaying the primary accepter and the case number is displayed. In addition, on the notification screen 160, a history field 162 displaying a history of messages exchanged in the past with the primary accepter in relation to the work with the case number displayed in the name field 161 is provided. Additionally, at the bottom of the history field 162, the content of the work involving the secondary accepter is displayed.

For example, in the example illustrated in FIG. 16, User B and the case number 123 are displayed in the name field 161 on the notification screen 160 of the user terminal 10A of User A, and at the bottom of the history field 162, “User C created the diagrams in the proposal.” is displayed. Note that the language displayed at the bottom of the history field 162 is not particularly limited. Any form of expression is acceptable insofar as the requester (User A) is able to understand how the secondary accepter (User C) was involved with the product that the primary accepter (User B) has delivered and the requester (User A) has inspected.

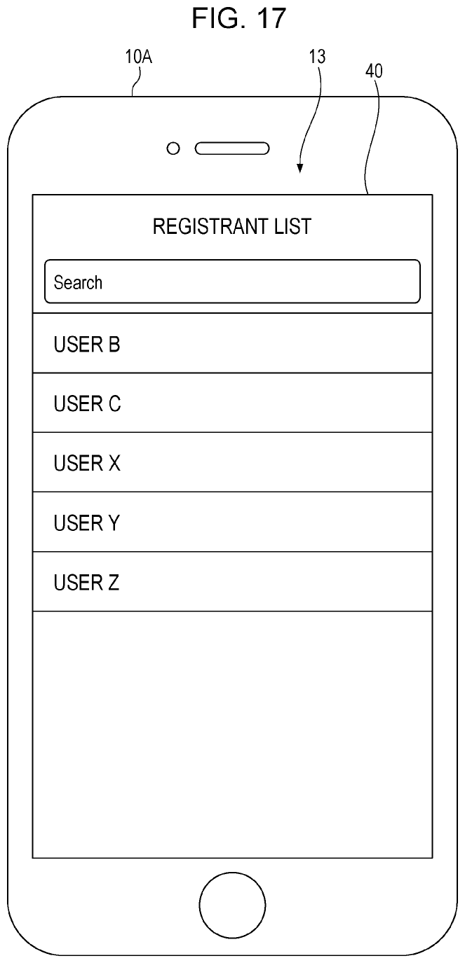

FIG. 17 is a diagram illustrating one example of the management screen 40 displayed on the user terminal 10A.

In the case in which, after the requester presses the inspect button 124 illustrated in FIG. 12, the transmitting unit 218 notifies the requester with information indicating that the primary accepter requested the secondary accepter to do a part of the requested work, the registration unit 220 of the server 20 stores the secondary accepter in association with the requester in the storage unit 22. With this arrangement, a new connection is formed between the requester and the secondary accepter.

As a result, the secondary accepter is newly displayed on the management screen 40 displayed on the user terminal 10 of the requester. Additionally, the requester becomes able to request the person who was the secondary accepter in the current transaction to do work in subsequent transactions.

For example, on the management screen 40 illustrated in FIG. 17, unlike the management screen 40 illustrated in FIG. 4, User C is displayed as a registrant.

Note that the timing when the transmitting unit 218 notifies the requester with information indicating that the primary accepter has requested the secondary accepter to do a part of the requested work may also be before the primary accepter delivers the product corresponding to the requested work. For example, the timing may also be after the allowing unit 219 allows the request of work from the primary accepter to the secondary accepter.

Even in the case in which the transmitting unit 218 notifies the requester before delivery, the registration unit 220 may store the secondary accepter in association with the requester in the storage unit 22 after the requester presses the inspect button 124 on the inspection screen 120 illustrated in FIG. 12. With this arrangement, after the requester checks the quality of the finished product of the work that the secondary accepter was responsible for, a new connection is formed between the requester and the secondary accepter.

Also, in the case in which the transmitting unit 218 notifies the requester immediately after the allowing unit 219 allows the request of work from the primary accepter to the secondary accepter, the registration unit 220 may also store the secondary accepter in association with the requester in the storage unit 22 immediately after the allowing unit 219 allows the request of work from the primary accepter to the secondary accepter. With this arrangement, the requester forms a new connection with the secondary accepter earlier. The requester becomes able to treat the person that the primary accepter wants to request to do work as a trustworthy person and request the person to do work, even before the requester checks the quality of the finished product that the secondary accepter is responsible for.

As described above, the work request support system 1 is provided with the receiving unit 211 as one example of a receiver that receives, from a requester who requests someone to do work, a request of work with respect to a registrant who serves as one example of a first person who has engaged in a transaction with the requester in the past. Also, the server 20 is provided with the allowing unit 219 as one example of an allower that allows the first person to request a candidate who serves as one example of a second person different from the first person to do work, and the storage unit 22 as one example of storage that stores the second person in association with the requester after the allowing unit 219 allows the request.

Since the storage unit 22 stores the second person (candidate, secondary accepter) in association with the requester after the allowing unit 219 allows the request, the second person becomes a new registrant. Additionally, the second person is the person whom the first person wants to request to do work, and also the person allowed by the allowing unit 219. Therefore, the requester forms a new connection with the trustworthy second person. As a result, the requester immediately becomes able to request the second person to do work.

Note that the first person is a person who has engaged in a transaction with the requester in the past, but is not limited to being a person who has engaged in a transaction through the work request support system 1. For example, the first person also includes a person who is in an organization or community to which the requester belongs and who has engaged in a transaction without going through the work request support system 1. Also, the first person is a person who has engaged in a transaction with the requester in the past, but is not limited to a person who has engaged in a transaction directly. For example, like the relationship between User A and User C described above, the first person may also be a person who has engaged in a transaction indirectly through User B.

Also, the work that the first person requests the second person different from the first person to do may be all of the work requested by the requester (for example, the creation of a proposal), or a part of the work requested by the requester (for example, the creation of diagrams in a proposal).

Herein, the allowing unit 219 preferably allows a request in the case in which the second person has engaged in a transaction with the first person in the past. This is because the desire to request a person with whom one has engaged in a transaction in the past to do work conceivably is because the second person is trustworthy.

In addition, the allowing unit 219 may also allow a request in the, case in which the requester understands that the first person is requesting the second person to do work. For example, in the work request support system 1 described above, after the request detecting unit 212 of the server 20 detects that the primary accepter, that is, User B, wants to request User C to do work, the transmitting unit 218 notifies the requester that a request of work from User B to User C is desired. Subsequently, in the case in which the requester sees the notification, such as in the case in which the receiving unit 211 receives information indicating that the requester has seen a message sent by the transmitting unit 218 indicating that a request of work from User B to User C is desired, for example, the allowing unit 219 may interpret the requester as understanding the situation and allow the request. With this arrangement, when the first person selects a person to request to do work, it becomes possible to make the first person make the selection more judiciously. With this arrangement, the quality of the finished product of the work requested by the requester rises.

Also, the storage unit 22 stores a registrant as one example of a transaction partner who has engaged in a transaction with the requester in the past, and the receiving unit 211 receives a request directed at a person selected from among registrants stored in the storage unit 22. With this arrangement, it becomes possible to cause the requester to request a trustworthy person to do work.

Also, the storage unit 22 may store an evaluation of a registrant in association with the registrant, and the receiving unit 211 may receive a request directed at a person selected from a list presented to the requester that includes the names and evaluation information of the registrants stored in the storage unit 22. With this arrangement, the requester becomes able to request work to a person who is more reliably trustworthy and highly valuable. Note that a registrant preferably is evaluated by someone other than the registrant. For example, a person who has requested the registrant to do work in the past evaluates the registrant on the basis of the quality of the finished product of the work performed by the registrant. In the example described above, User B evaluates User C in consideration of the quality of the diagrams created by User C. The server 20 preferably enables one to evaluate a registrant via the registrant screen 50, for example.

Also, the work request support system 1 additionally is provided with the granting unit 217 as one example of a granter that grants a remuneration to the primary accepter who serves as one example of the first person in the case in which requested work is completed. With this arrangement, the requester requests work more easily. Also, the person requested to do work receives work more easily. As a result, more people will want to form connections with other through the work request support system 1.

The granting unit 217 preferably grants a remuneration determined by the requester. With this arrangement, it becomes possible for the requester to grant a remuneration according to the quality of the finished product of the work performed by the person who accepted the requested work.

Also, the remuneration that the granting unit 217 grants to the primary accepter who serves as one example of the first person preferably is a remuneration determined by the requester, while the remuneration that the granting unit 217 grants to the secondary accepter who serves as one example of the second person preferably is a remuneration determined by the primary accepter. With this arrangement, the requester becomes able to grant a remuneration according to the quality of the finished product of the work performed by the primary accepter, and the primary accepter becomes able to grant a remuneration according to the quality of the finished product of the work performed by the secondary accepter.

Note that in the exemplary embodiment described above, as illustrated in FIG. 14, the requester inputs “JPY 100,000” into the input field 143 of the remuneration setting screen 140 as the remuneration to grant to the primary accepter, but the remuneration is not limited particularly to such a configuration. The amount input into the input field 143 of the remuneration setting screen 140 may also be a percentage of a monetary amount reserved in advance when making the request or the like, for example. For example, when making the request or the like, the requester may reserve money as a remuneration for the requested work and also disclose the monetary amount, and input a percentage of the monetary amount into the input field 143 of the remuneration setting screen 140. For example, the requester may reserve JPY 100,000 and also disclose that JPY 100,000 is reserved as the remuneration for the requested work, and by inputting 100% into the input field 143 of the remuneration setting screen 140, the requester may grant the entire JPY 100,000 to the primary accepter.

Also, in the exemplary embodiment described above, the remuneration to grant to the secondary accepter is decided by the primary accepter, but is not particularly limited to such a configuration. The requester may also decide the remuneration to grant to the secondary accepter. For example, the requester may decide to grant JPY 80,000 to the primary accepter and JPY 20,000 to the secondary accepter as the remuneration. Also, the requester may decide to grant 80% to the primary accepter and 20% to the secondary accepter as the remuneration with respect to the money (for example, JPY 100,000) reserved in advance.

Additionally, the remuneration that the requester grants to each accepter does not have to be money. The granting unit 217 of the server 20 may also grant points or virtual currency having a monetary value. The points may be points used to receive a discount at partner locations of cooperating stores, such as T Points, Rakuten Points, Ponta Points, or d Points.

Also, the placement positions of the name fields, history fields, input fields, and various buttons provided on the various screens displayed on the user terminals 10 are not particularly limited.

Also, in the exemplary embodiment described above, each of the primary accepter and the secondary accepter is a single individual, but may also be multiple persons. In other words, even for the same case, the requester may request multiple persons to do work, and the primary accepter may also request multiple persons to do work. Also, for example, multiple secondary accepters may be requested to do different types of work, such as requesting one secondary accepter to create the diagrams and requesting another secondary accepter to proofread the proposal.

The processes executed by the control unit 11 of the user terminal 10 and the control unit 21 of the server 20 described above may be realized by the cooperative action of software and hardware resources. In this case, the CPU of the control unit 11 or the control unit 21 executes a process realizing each function of the control unit 11 or the control unit 21, and causes each of these functions to be realized. For example, a non-transitory computer-readable recording medium storing the program is provided to the control unit 11 or the control unit 21, and the CPU reads out the program stored on the recording medium. In this case, the program itself read out from the recording medium realizes the functions of the exemplary embodiment described above, and the program itself as well as the recording medium storing the program form the present disclosure. The recording medium for supplying such a program may be, for example, a flexible disk, a CD-ROM, a DVD-ROM, a hard disk, an optical disc, a magneto-optical disc, a CD-R, magnetic tape, a non-volatile memory card, or ROM. Additionally, the program may also be downloaded to the user terminal 10 or the server 20 over the network 30.

Additionally, the program forming the present disclosure is a program causing a computer to execute a process for supporting a work request, the process including receiving, from a requester who requests a person to do work, a request of work with respect to a first person who has previously engaged in a transaction with the requester, allowing the first person to request a second person different from the first person to do work, and storing the second person and the requester in association with each other after allowing the request from the first person.

Also, the program forming the present disclosure may additionally cause the computer to execute a process including granting a remuneration to the first person in a case in which requested work is completed.

### Second Exemplary Embodiment

In the server 20 according to the second exemplary embodiment, the allowing unit 219 is different from the server 20 according to the first exemplary embodiment. Hereinafter, the points that differ from the server 20 according to the first exemplary embodiment will be described. Parts having the same function in the first exemplary embodiment and the second exemplary embodiment are denoted with the same signs, and detailed description is omitted.

The allowing unit 219 according to the second exemplary embodiment allows the primary accepter to requester another person to do a part of the work requested by the requester in the case in which the requester gives approval.

In the case in which the request detecting unit 212 of the server 20 detects that the primary accepter wants to request another person to do the work input into the input field 62 on the work request screen 60, the transmitting unit 218 of the server 20 notifies the requester that the primary accepter is making a request to another person.

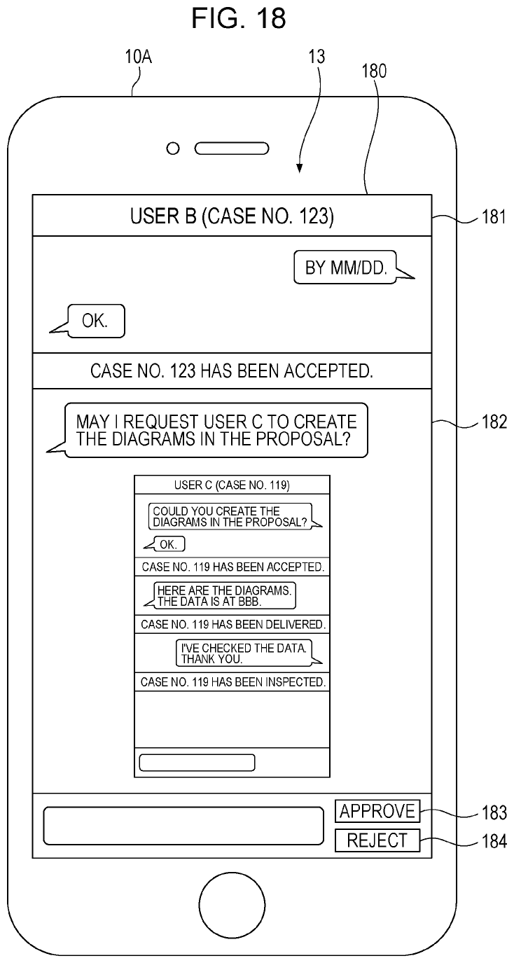

FIG. 18 is a diagram illustrating one example of an approval screen 180.

The approval screen 180 is displayed on the display unit 13 in the case in which the requester presses the part where the case number is displayed on the registrant screen 50 for the primary accepter.

On the approval screen 180, a name field 181 displaying the primary accepter and the case number is displayed. In addition, on the approval screen 180, a history field 182 displaying a history of messages exchanged in the past with the primary accepter in relation to the work with the case number displayed in the name field 181 is provided. Also, on the approval screen 180, an approve button 183 labeled “Approve” and a reject button 184 labeled “Reject” are displayed.

Additionally, in the history field 182 on the approval screen 180, a history of the messages exchanged during a past transaction between the primary accepter and the candidate is displayed.

For example, in the example illustrated in FIG. 18, User B and the case number 123 are displayed in the name field 181 on the approval screen 180 of the user terminal 10A of User A, and at the bottom of the history field 182, a history of messages of a transaction engaged in by User B and User C in the past, namely a case number 119, is displayed.

When the user presses the approve button 183 displayed on the approval screen 180, the receiving unit 211 of the control unit 21 of the server 20 receives information indicating that the approve button 183 has been pressed. Subsequently, the allowing unit 219 according to the second exemplary embodiment allows the primary accepter to request the candidate to do a part of the work that the requester requested the primary accepter to do.

In the case in which the allowing unit 219 allows the request, the transmitting unit 218 notifies the person (candidate) who is to receive a request of work from the primary accepter that a work request from the primary accepter has arrived, and also notifies the primary accepter that the work request to the candidate has been allowed.

On the other hand, in the case in which the user presses the reject button 184 displayed on the approval screen 180, the receiving unit 211 receives information indicating that the reject button 184 has been pressed. Subsequently, the allowing unit 219 according to the second exemplary embodiment does not allow the primary accepter to request the candidate to do a part of the work that the requester requested the primary accepter to do. In addition, in the case in which the allowing unit 219 does not allow the request, the transmitting unit 218 notifies the primary accepter that the request to the candidate is not allowed.

For example, in the example illustrated in FIG. 18, in the case in which User A presses the approve button 183 on the approval screen 180, the allowing unit 219 allows the work request from User B to User C, while the transmitting unit 218 notifies User C that a work request from User B has arrived, and also notifies User B that the work request to User C has been allowed. On the other hand, in the case in which User A presses the reject button 184 on the approval screen 180, the allowing unit 219 does not allow the work request from User B to User C, and the transmitting unit 218 notifies User B that the work request to User C is not allowed.

As described above, the allowing unit 219 according to the second exemplary embodiment allows a work request from the primary accepter who serves as one example of the first person to the candidate who serves as one example of the second person in the case in which the requester allows (approves) the request. With this arrangement, the requester minimizes a loss of quality in the finished product of the work caused by the primary accepter taking the liberty of requesting another person to do the work. Also, when the first person selects a person to request to do work, it becomes possible to make the first person make the selection more judiciously. With this arrangement, the quality of the finished product of the work requested by the requester rises.

Also, the allowing unit 219 according to the second exemplary embodiment preferably allows the work request to the second person in the case in which the requester allows the request after understanding a past transaction between the primary accepter who serves as one example of the first person and the candidate who serves as one example of the second person. With this arrangement, the requester more easily judges whether or not to allow the work request from the first person to the second person.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A work request support system comprising:
a receiver that receives, from a requester who requests a person to do work, a request of work with respect to a first person who has previously engaged in a transaction with the requester;
an allower that allows the first person to request a second person different from the first person to do work; and
storage that stores the second person and the requester in association with each other after the allower allows the request from the first person.

2. The work request support system according to claim 1, wherein
the allower allows the request from the first person in a case in which the second person has previously engaged in a transaction with the first person.

3. The work request support system according to claim 2, wherein
the allower allows the request from the first person in a case in which the requester understands that the first person is requesting the second person to do work.

4. The work request support system according to claim 1, wherein
the allower allows the request of work from the first person to the second person in a case in which the requester allows the request of work from the first person to the second person.

5. The work request support system according to claim 4, wherein
the allower allows the request of work to the second person in a case in which the requester allows the request of work to the second person after understanding a past transaction between the first person and the second person.

6. The work request support system according to claim 1, wherein
the storage stores transaction partners with whom the requester has previously engaged in transactions, and
the receiver receives a request to a person selected from among the transaction partners stored in the storage.

7. The work request support system according to claim 6, wherein
the storage stores an evaluation of the transaction partners in association with the transaction partners, and
the receiver receives a request to a person selected from a list, presented to the requester, that includes names and evaluation information of the transaction partners stored in the storage.

8. The work request support system according to claim 1, further comprising:
a granter that grants a remuneration to the first person in a case in which requested work is completed.

9. The work request support system according to claim 8, wherein
the granter grants a remuneration determined by the requester.

10. The work request support system according to claim 9, wherein
the remuneration that the granter grants to the first person is a remuneration determined by the requester, and the remuneration that the granter grants to the second person is a remuneration determined by the first person.

11. A non-transitory computer readable medium storing a program causing a computer to execute a process for supporting a work request, the process comprising:
receiving, from a requester who requests a person to do work, a request of work with respect to a first person who has previously engaged in a transaction with the requester;
allowing the first person to request a second person different from the first person to do work; and
storing the second person and the requester in association with each other after allowing the request from the first person.

12. The non-transitory computer readable medium according to claim 11, wherein the process further comprises:
granting a remuneration to the first person in a case in which requested work is completed.
